(19) United States
(12) Patent Application Publication
(10) Pub. No.: US 2011/0025087 A1
(43) Pub. Date: Feb. 3, 2011

(54) HINGED ACCESS DOOR SYSTEM

(75) Inventor: Sandro Ramos, High Point, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: VOLVO GROUP NORTH AMERICA, INC., Greensboro, NC (US)

(21) Appl. No.: 12/511,428

(22) Filed: Jul. 29, 2009

(51) Int. Cl. B62D 25/00; E05F 11/00

(52) U.S. Cl. 296/97.22; 49/323

(57) ABSTRACT

An access door system includes a door, a bezel, and a hinge. The door is provided with an open position and a closed position. The hinge connects the door and the bezel and is provided with an end journaled to the bezel about an axis of rotation. The hinge rotating about the axis of rotation between a first position, whereat the door is open, and a second position, whereat the door is closed. One of the hinge or the bezel is provided with a detent receiving portion. The other of the door or the bezel is provided with a detent. The detent receiving portion releasably receives the detent to releasably hold the door in a position.

### FIELD OF THE INVENTION

The present invention relates to an access door system and, particularly, to an access door system that may be included on a vehicle body.

### BACKGROUND OF THE INVENTION

Vehicles, such as, for example, trucks and cars, are typically provided with one or more hinged access doors. By way of example, and not limitation, many vehicles include hinged access doors that are used to selectively cover and provide access to a gas tank. Such hinged access doors typically include one or more springs that are used for purposes of mounting, biasing, or controlling the opening and closing of the door.

Selective Catalytic Reduction (“SCR”) emission control systems are becoming more and more common place on vehicles and equipment. SCR systems utilize urea (“(NH₂)₂CO”) for purposes of reducing emissions. The urea is stored in a tank. It may be desirable to utilize a hinged access door to selectively cover and provide access to a urea tank.

Urea, which may be aqueous or gaseous, imparts a corrosive nature to the local environment. Due to this corrosive nature, special measures should be taken to ensure that hinged access doors are suitable use in such an environment. Not only should the door itself be immune to the effects of the corrosive environment, but any mounting hardware, such as springs, clips, or fasteners, should also be immune to the corrosive effects of the environment.

While a corrosive resistant material, such as stainless steel, may be used, it may prove costly to manufacture the entire assembly, including the springs, from such a material. Furthermore, the very use of springs entails additional labor during installation. Such installation may also prove difficult due to the confined nature of the area. This may be particularly problematic, where it is an option to purchase a vehicle or equipment with a complete access door assembly, i.e. bezel, door, and any mounting hardware, or with an incomplete access door assembly, i.e. just a bezel without the door and mounting hardware. In such a situation, subsequent to purchasing a vehicle or equipment with an incomplete access door assembly, i.e. with just a bezel, a user may decide to upgrade and purchase the door. Simple installation may prove difficult for such a purchaser, and installation may require professional assistance and special tools.

The present invention is directed to an improved access door system

### SUMMARY OF THE INVENTION

According to one embodiment of the present invention, an access door system includes a door, a bezel, and a hinge. The door is provided with an open position and a closed position. The hinge connects the door and the bezel and is provided with an end journaled to the bezel about an axis of rotation. The hinge rotating about the axis of rotation between a first position, whereat the door is open, and a second position, whereat the door is closed. One of the hinge or the bezel is provided with a detent receiving portion. The other of the door or the bezel is provided with a detent. The detent receiving portion releasably receives the detent to releasably hold the door in a position.

### BRIEF DESCRIPTION OF THE DRAWINGS

FIG. 1 is a perspective view of the access door system according to one embodiment showing the hinges in a first position and the door in an open position.

FIG. 2 is a perspective view of the access door system according to one embodiment showing the hinges in a second position and the door in an open position.

FIG. 3 is a perspective view of the bezel according to one embodiment.

FIG. 4 is a perspective view of the bezel according to one embodiment.

FIG. 5 is a side perspective view of the bezel according to one embodiment.

FIG. 6 is a side perspective view of the bezel according to one embodiment showing the side opposite that to the one shown in FIG. 5.

FIG. 7 is a perspective view of the access door system according to one embodiment showing the hinges in the second position and the door in the closed position.

FIG. 8 is a perspective view of the access door system according to one embodiment showing the hinges in a second position and the door in an open position.

FIG. 9 is a perspective view of the bezel according to one embodiment.

FIG. 10 is a perspective view of the hinges and door according to one embodiment.

FIG. 11 is a close up view showing detent receiving portions on the bezel according to one embodiment.

FIG. 12 is a sectional view showing detents on the hinges according to one embodiment.

FIG. 13 is a close up view of a vehicle body showing an opening and a urea access according to one embodiment.

### DETAILED DESCRIPTION OF THE INVENTION

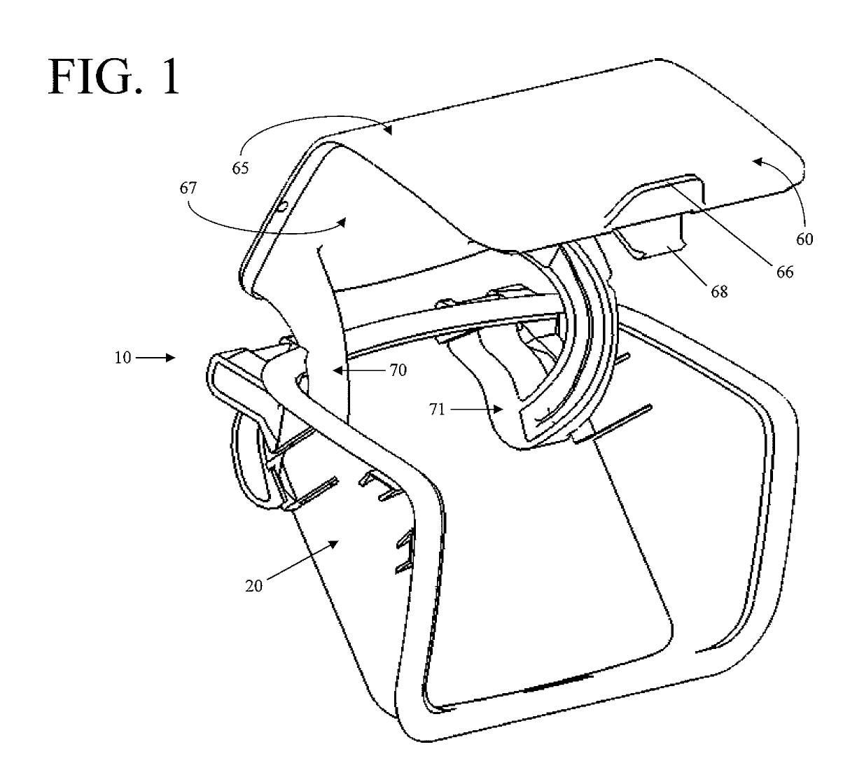

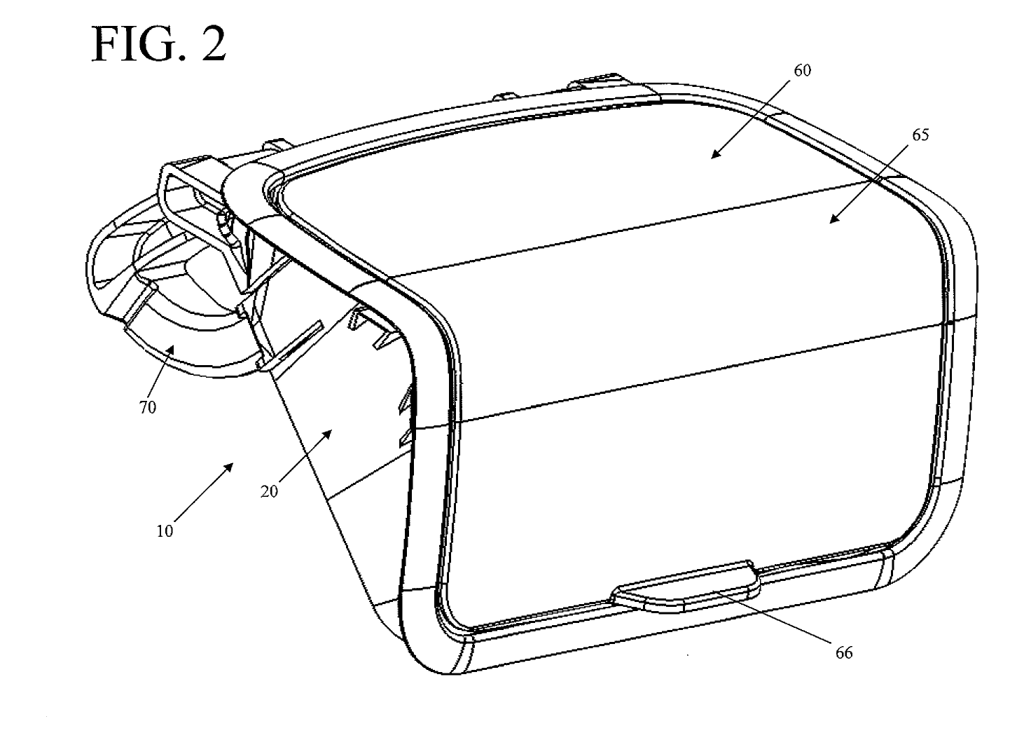

FIGS. 1-2 depict an access door system 10 according to a preferred embodiment of the present invention. As shown therein, the access door system 10 of the present embodiment is preferably provided with a bezel 20, a door 60, and hinges 70, 71. While in the present embodiment, the hinges 70, 71 and door 60 are shown as a unitary structure, those of ordinary skill in the art will appreciate that it is within the scope of the present embodiment to fabricate the hinges 70 and door 60 as discrete components and assemble them together in any fashion.

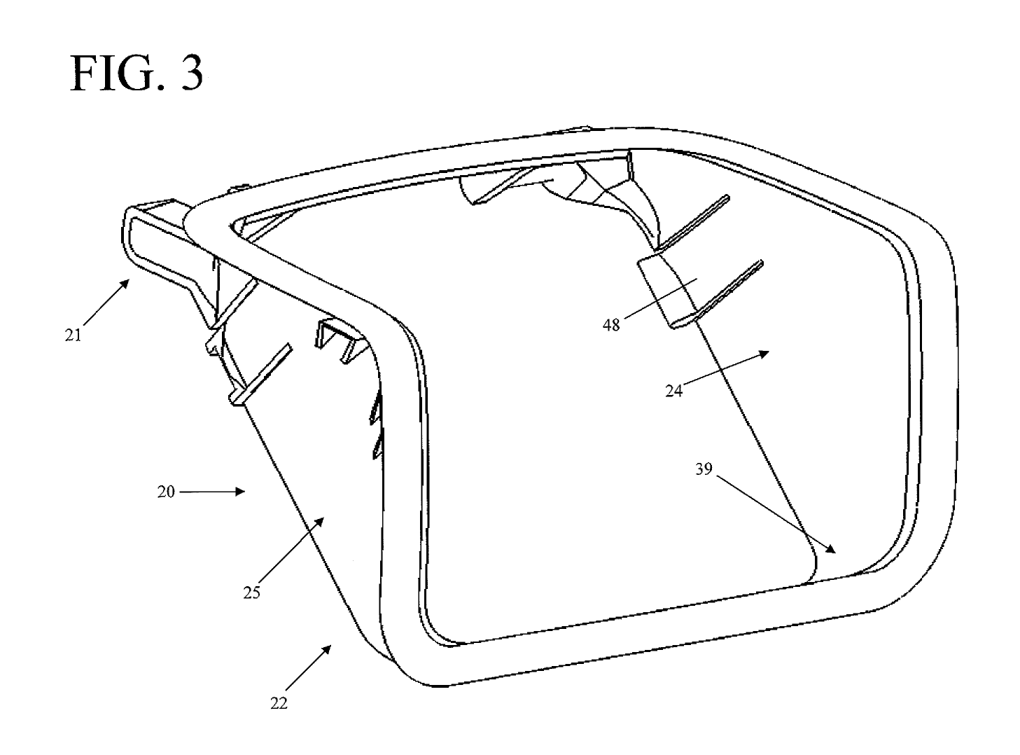

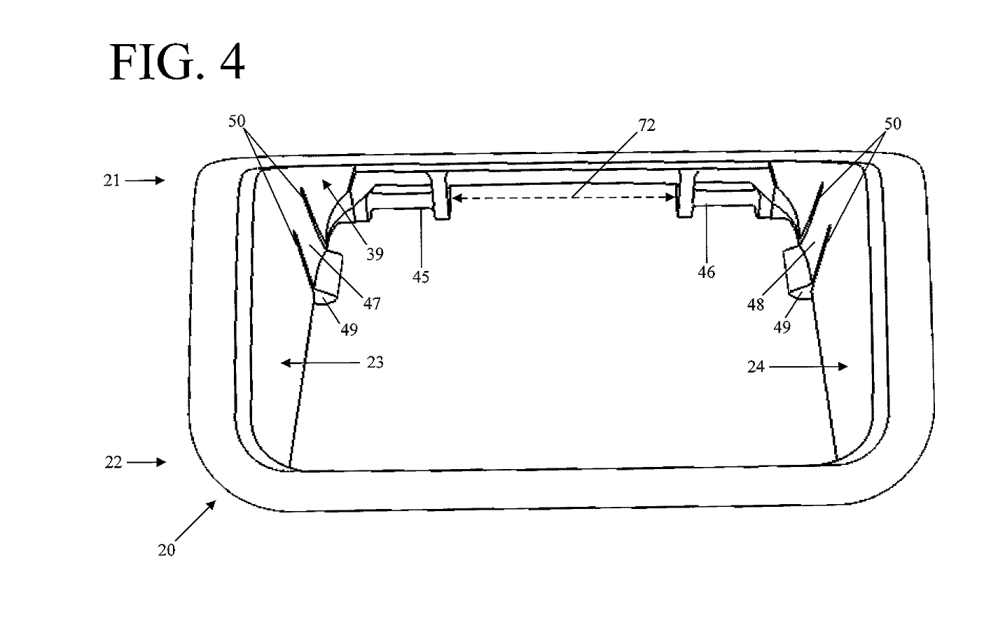

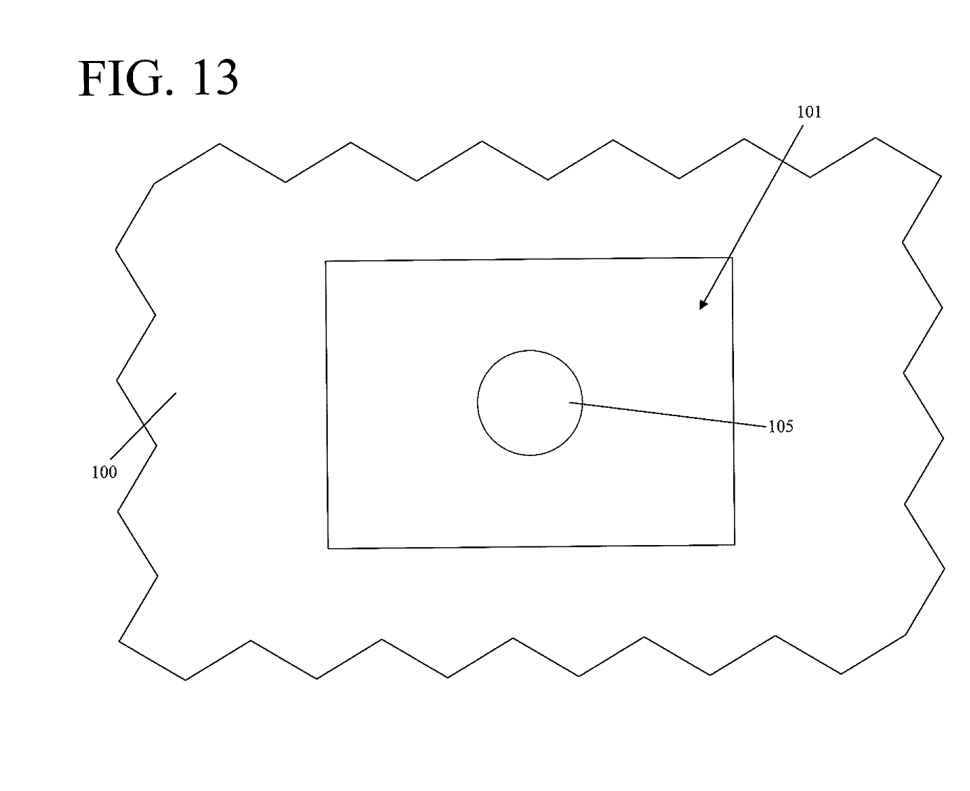

Turning now to FIGS. 3 and 4, the bezel 20 of the preferred embodiment is depicted. As shown in FIG. 3, the bezel 20 is provided with an outer surface 25. According to one aspect of the present embodiment, the outer surface 25 may be configured to cooperate with a vehicle body 100, such as that depicted in FIG. 13, for purposes of securing the bezel 20 to the vehicle body 100, such as for example the portion of a vehicle body 100 that surrounds a tank access, including, but not limited to, a urea tank access 105 (FIG. 13), which may be a releasable cap. In the present embodiment, the bezel 20 may be configured for installation on the chassis fairing of the vehicle body 100, such as, for example, a tractor-trailer. Those of ordinary skill in the art will appreciate that the bezel 20 may, within the scope of the present embodiment, be installed on other equipment and devices, as well

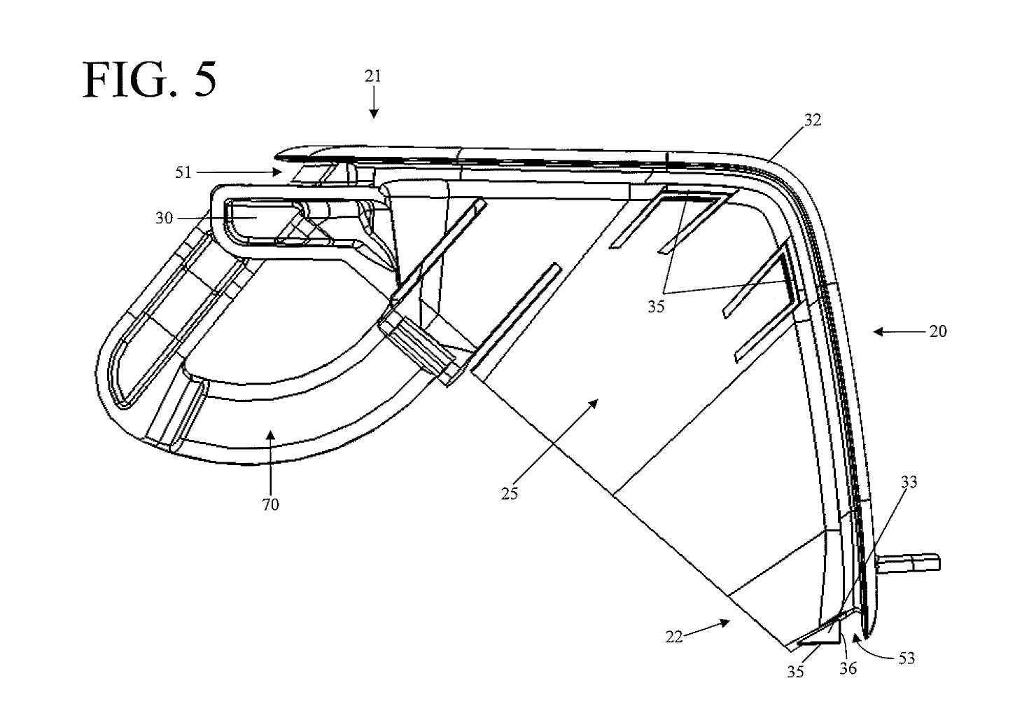

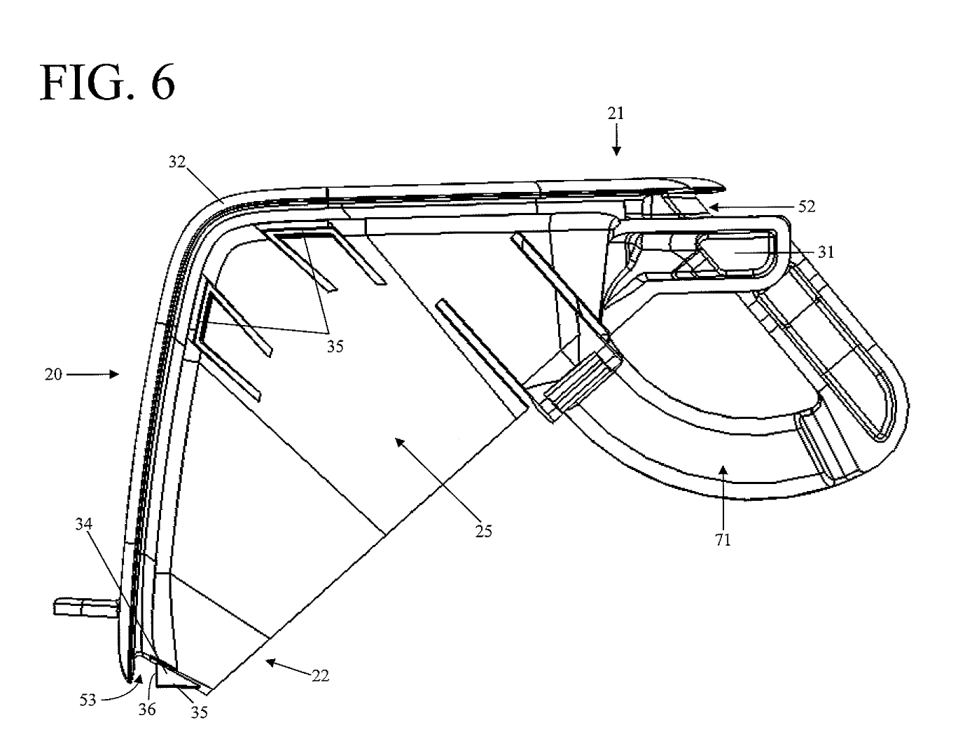

As shown in FIGS. 5 and 6, on the first end 21 of the bezel 20, the outer surface 25 may define one or more catches, such as, for example, 30, 31, which receive a portion of the vehicle body 100. In the embodiment depicted, the outer surface 25 includes a first catch 30 and a second catch 31. Also shown in FIGS. 5 and 6, the outer surface 26, may define a lip 32. As shown in FIGS. 5 and 6, the catches 30, 31 may cooperate with the underside of the lip 32 to define slots 51, 52. The slots 5, 521 may that receive a portion of the vehicle body 100 defining the upper end of an opening 101 in the vehicle body 100 (FIG. 13).

As shown in FIGS. 5 and 6, on a second end 22 of the bezel 20, the outer surface 25 may define one or more snap clips, such as, for example 33, 34. In the embodiment depicted, the outer surface 25 includes a first snap clip 33 and a second snap clip 34. According to one aspect of the present embodiment the first snap clip 33 and the second snap clip 34 may be configured to snap fit to the vehicle body 100. As shown in FIGS. 5 and 6, the snap clips 33, 34 may include a ramped surface 35 and a retaining surface 36. In the present embodiment, during installation, after the slots 51, 52 defined by the catches 30, 31 and the underside of the lip 32 receive the vehicle body 100, the second end 22 of the bezel 20 may be forced towards the lower end of the opening 101 defined by the vehicle body 100. As this occurs, the ramped surface 35 contacts the surface of the vehicle body 100 that defines the lower periphery of the opening 101.

As the second end 22 of the bezel 20 is continued to be forced in the direction of the opening 101 of the vehicle 100, the ramped surface 35 slides against the periphery of the opening 101. According to one aspect of the present embodiment, the ramped surface 35 may be angled so as to cause one or both of the bezel 20 or vehicle body 100 to elastically flex, whereby once the ramped surface 35 moves past the periphery of the opening 101, one or both of vehicle body 100 or bezel 20 resiliently snap towards the other, whereupon the retaining surface 36 cooperates with the underside of the lip 32 to capture a portion of the vehicle body 100 within slots 53, 54 defined by the underside of the lip 32 and the retaining surface 36.

Those of ordinary skill in the art will appreciate that the outer surface 25 of the bezel 20 may be provided with additional catches and additional snap clips. By way of example, and not limitation, as shown in FIGS. 5 and 6 the sides 28, 29 of the outer surface 25 may be provided with additional snap clips, as at 35. Furthermore, those of ordinary skill in the art will appreciate that other arrangements may be employed within the scope of the present invention for purposes of mounting the bezel 20 to the vehicle body 100. By way of example, and not limitation, the catches 30, 31 may be replaced with snap clips, adhesive may be used, and threaded fasteners or other fasteners, such as, for example, rivets may be utilized.

Turning now back to FIGS. 3 and 4, the bezel 20 is provided with an inner surface 39. According to one aspect of the present embodiment, the inner surface 39 is configured to connect to the hinges 70, 71. As shown in FIG. 4, in the present embodiment, on the first end 21 of the bezel 20, the inner surface 39 may be provided with a first bearing 45 and a second bearing 46, which may take the form of discrete bearings, as shown, or may be provided as a unitary bearing. As shown in the embodiment depicted, the first and second bearings 45, 46 may be located on inward facing sides of the catches 30, 31, whereby they extend from the catches 30, 31 towards each other.

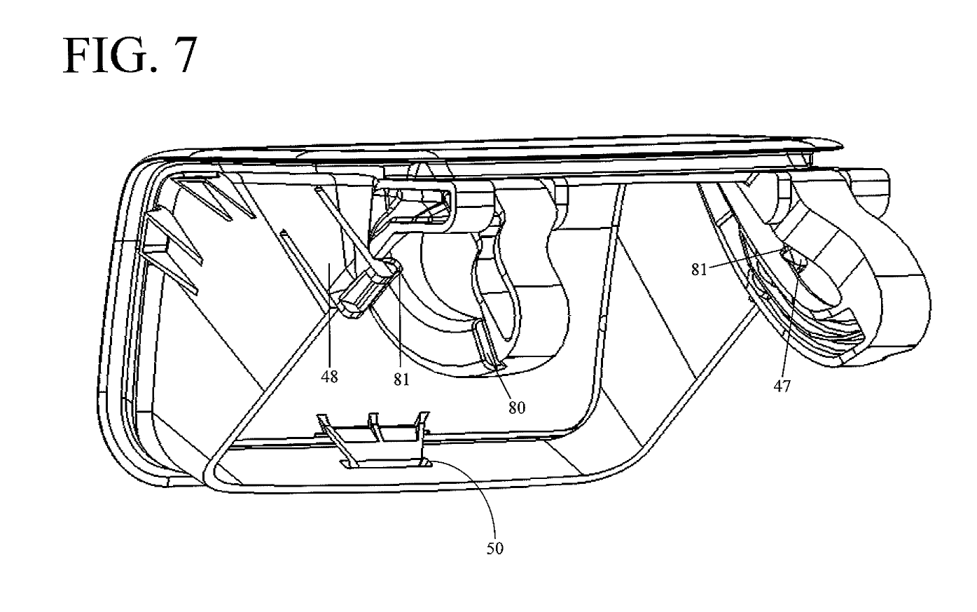

In the present embodiment, first ends 73 of the hinges 70, 71 are journaled to the respective bearings 40, 41 whereby the hinges 70, 71 are provided with an axis of rotation 72 (FIG. 7) that extends through the first ends 73 of the hinges 70, 71 and through the bearings 45, 46. In the presently preferred embodiment, the hinges 70, 71 may be releasably snap fit to the bearings 45, 46, whereby the first ends 73 are releasably journaled to the bezel 20; however, those of ordinary skill in the art will appreciate that it is within the scope of the present embodiment to mount the hinges 70, 71 to the bearings 45, 46 in any suitable manner.

According to another aspect of the present embodiment, the inner surface 39 is configured to releasably hold the hinges 70, 71 in one or more positions. As shown in FIGS. 1 and 2, the hinges 70, 71 include a first position, whereat the door 60 is open (FIG. 1), and a second position, whereat the door 60 is closed (FIG. 2). In the present embodiment, the inner surface 39 may releasably hold the hinges 70, 71 in any number of positions, including the first position and the second position.

As shown in FIGS. 3 and 4, on the sides 23, 24 of the bezel 20, the inner surface 39 may include opposing first and second detents 47, 48. According to one aspect of the present embodiment, the first and second detents 47, 48 may releasably engage an open position detent receiving portion 80 provided on the hinges 70, 71 to releasably hold the hinges 70, 71 in the first position and the door 60 in the open position. According to another aspect of the present embodiment, the first and second detents 47, 48 may releasably engage a closed position detent receiving portion 81 provided on the hinges 70, 71 to releasably hold the hinges 70, 71 in the second position and the door 60 in the closed position.

In the present embodiment, the first and second detents 47, 48 may be provided as flexible members that flexibly and releasably snap into and out of the open and closed position detent receiving portions 80, 81 located on each of the hinges 70, 71. As shown, the first and second detents 47, 48 may be provided as cantilevered members having hooked ends 49, which flexibly and releasably snap into and out of the open and closed position detent receiving portions 80, 81 of said hinges 70, 71. As shown in the embodiment depicted, the detents 47, 48 may be defined by one or more elongated cutouts 50 formed into the first and second sides 42, 43. Also shown in the embodiment depicted, the detents 47, 48 may terminate in hooked ends 49, which preferably extend inward from the opposing sides 42, 43 such that the hooked ends 49 of the first and second detents 47, 48 extend toward each other.

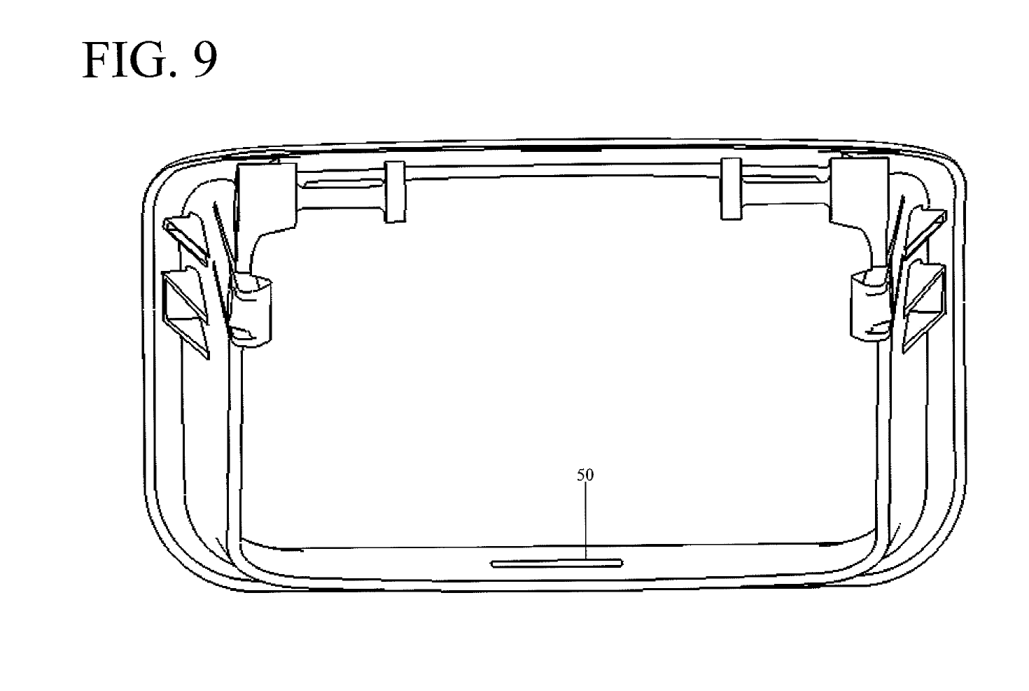

According to yet another aspect of the present embodiment, the inner surface 39 may be configured to cooperate with the door 60 to releasably hold the door 60 in the closed position. As shown in FIGS. 7 and 9, on the second end 22 of the bezel 20, the inner surface 39 may define a locking member receiving portion 50. The locking member receiving portion 50 may be provided with any shape, such as a recess or a cutout, which releasably receives a locking member 68, which is provided on the door 60, when the door 60 is in the closed position. In the present embodiment depicted, the locking member receiving portion 50 may be cutout portion defined into the inner surface 39, such that it defines an open volume that extends between the inner surface 39 and the outer surface 25.

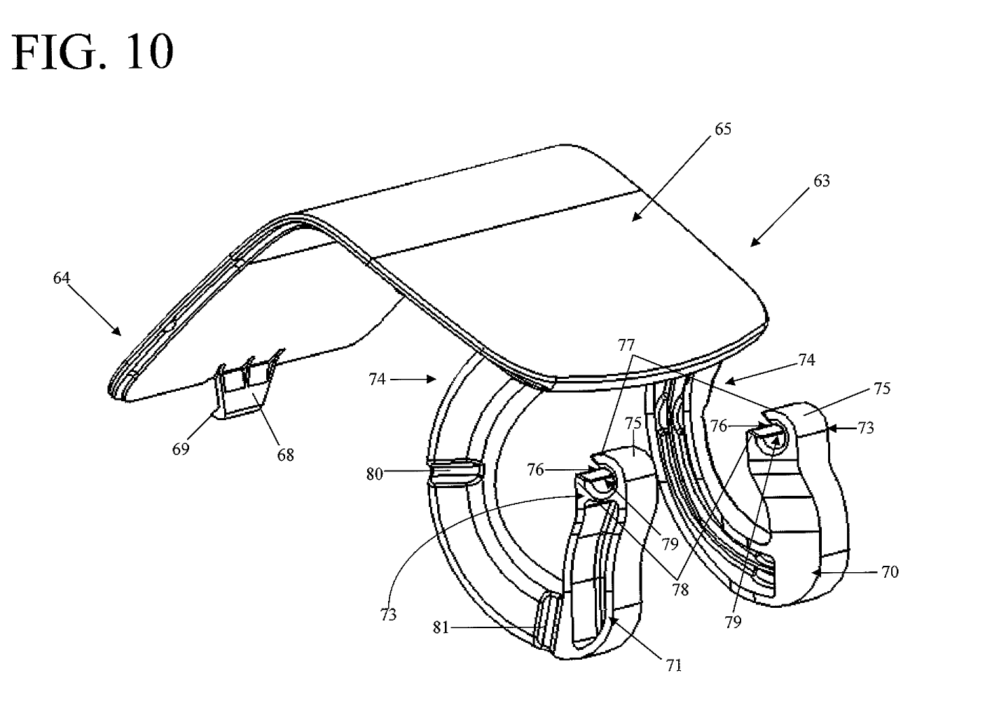

Turning now to FIGS. 1, 2, and 10, the door 60 of the presently preferred embodiment is depicted. As shown in FIGS. 1 and 2, the door 60 is provided with an open position and a closed position. Also shown therein, the door 60 is provided with an outer surface 65. According to one aspect of the present embodiment, the outer surface 65 may be configured to allow a user to manually open the door. As shown, the outer surface 65 may include a handle 66 that allows a user to grasp and position the door. As shown in the embodiment depicted, the handle 66 may be located at the second end 64 (FIG. 10) of the door 60; however, those of ordinary skill in the art will appreciate that other arrangements are within the scope of the present embodiment, including, but not limited to positioning the handle elsewhere or fabricating the door without a handle.

According to another aspect of the present embodiment, the door 60 may be configured to cooperate with the bezel 20 to releasably hold the door 60 in the closed position. As shown in FIG. 1, the door 60 may be provided with a locking member 68, which may be located on an inner surface 67 of the door 60. In the present embodiment, the locking member 68 may be configured to flexibly and releasably snap into and out of the locking member receiving portion 50 provided on the bezel 20. As shown in FIG. 10, the locking member 68 may be provided as a protruding cantilevered member that terminates at a hooked ends 69, which flexibly and releasably snap into and out of the locking member receiving portion 50. As shown in the embodiment depicted, the locking member 68 may extend from the second end 64 of the door 60; however, those of ordinary skill in the art will appreciate that other arrangements are within the scope of the present embodiment.

According to another aspect of the present embodiment, the door 60 is configured to connect to the hinges 70, 71. As shown in FIG. 10, the door 60 may be provided with a first end 63 where at the inner surface 67 may be secured to the hinges 70, 71; however, those of ordinary skill in the art will appreciate that other locations are within the scope of the present embodiment.

Turning now to FIG. 10, the hinges 70, 71 of the presently preferred embodiment are depicted. As shown therein, the hinges 70, 71 may include first ends 73 for securing to the bezel 20 and second ends 74 secured to the door 60. In the present embodiment, the hinges 70, 71 are depicted as “J” type hinges that are provided with a generally J shape; however, those of ordinary skill in the art will appreciate that other arrangements are within the scope of the present embodiment. Accordingly, those of ordinary skill in the art will appreciate that it is within the scope of the present invention to provide the hinges 70, 71 with a variety of shapes.

According to one aspect of the present embodiment, the hinges 70, 71, are configured to connect to the bezel 20. In the present embodiment, the first ends 73 of the hinges 70, 71 are journaled to the bearings 45, 46 on the bezel 20. According to one aspect of the present embodiment, the first ends 73 may be releasably journaled to the bearings 45, 46. As shown in FIG. 10, the hinges 70, 71 may include snapping members 75, which releasably snap around the bearings 45, 46. The hinges 70, 71 may be releasably journaled to the bezel 20 about the axis of rotation 72 (FIG. 4), whereby the axis of rotation 72 extends through the snapping members 75. The hinges 70, 71 may rotate about the axis of rotation 72 between the first position, whereat the door 60 is open, and the second position, whereat the door 60 is closed.

In the present embodiment, the hinges 70, 71 may be releasably secured to the bezel 20 by positioning the door 60 slightly past a normally fully open position, positioning the hinges 70, 71 within the bezel 20, and forcing a cutout portion 76 defined by the snapping members 75 towards the bearings 45, 46. As the snapping members 75 are forced against the bearings 45, 46 this causes at least one of two opposing arms 77, 78 on the snapping members 75 to elastically flex, whereby the diameter of the cutout portion 76 slightly increases to accommodate the diameter of the bearings 45, 46. As the cutout portion 76 is further forced past the bearings 45, 46, at least one of the arms 77, 78 resiliently snap towards the other to releasable capture the bearings 45, 46 within an bearing receiving portion 79 defined by the arms 77, 78. The arms 77, 78 extend semi-circumferentially around the bearing receiving portion 79 and, when the hinges 70, 71 are secured to the bezel 20, semi-circumferentially around the bearings 45, 46 and axis of rotation 72. Those of ordinary skill in the art will appreciate that in a similar, but opposite manner, the hinges 70, 71 may be released from the bezel 20.

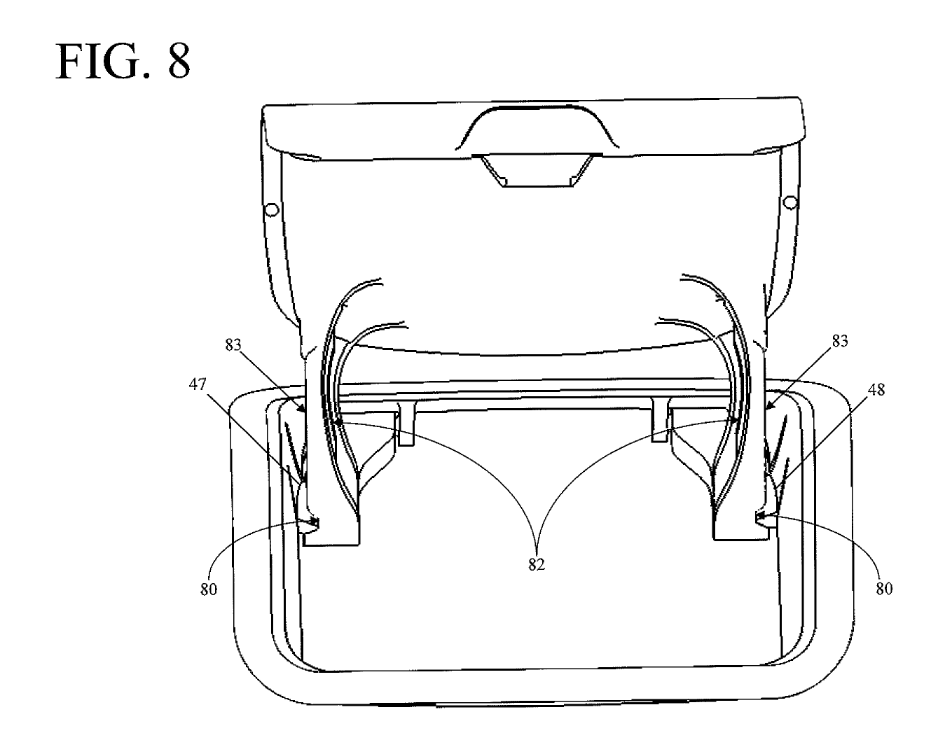

According to another aspect of the present embodiment, the hinges 70, 71 are configured to cooperate with the bezel 20 to releasably hold the hinges 70, 71 in one or more positions. In the presently preferred embodiment, the hinges 70, 71 may be provided with one or more detent receiving portions, such as, the open and closed position detent receiving portions 80, 81. According to one aspect of the present embodiment, as shown in FIG. 8, the open position detent receiving portions 80 on the first and second hinges 70, 71 may releasably receive the respective first and second detents 47, 48 on the bezel 20 to releasably hold the hinges 70, 71 in the first position whereat the door 60 is open. According to one aspect of the present embodiment, as shown in FIG. 7, the closed position detent receiving portions 81 on the first and second hinges 70, 71 may releasably receive the respective first and second detents 47, 48 on the bezel 20 to releasably hold the hinges 70, 71 in the second position, whereat the door 60 is closed. In the present embodiment, the hinges 70, 71 flex inward somewhat to assist in releasing the detents 47, 48 from the detent receiving portions 80, 81.

In the present embodiment, the detent receiving portions 80, 81 may be provided as a recessed area or cut outs defined within said hinges 70, 71. In FIG. 8, the hinges 70, 71 are shown including inward facing sides 82 and outward facing sides 83. The inward facing sides 82 of the hinges 70, 71 face each other. The outward facing sides 83 of the hinges 70, 71 face in a generally opposite direction than the inward facing sides 82. As shown, the open and closed position detent receiving portions 80, 81 may be located on the outward facing sides 83 of the hinges 70, 71. Furthermore, as shown, the open position detent receiving portions 80 may be positioned along the hinges 70, 71 at a position that is located closer to the bezel 20 than the closed position detent receiving portions 81.

According to one aspect of the present embodiment, the access door system 10 may be fabricated using a plastic. According to another aspect of the present embodiment, the access door system 10 may be fabricated using a thermoplastic. According to yet another aspect of the present embodiment, the access door system 10 may be fabricated using a thermoset. According to still another aspect of the present embodiment, the access door system 10 may be fabricated using a fiber, such as, for example, a glass fiber or carbon fiber. According to still yet another aspect of the present embodiment, the access door system 10 may be fabricated using molding. According to a further aspect of the present embodiment, the access door system 10 may be fabricated using injection molding. In the presently preferred embodiment, the access door system 10 is fabricated from Polycarbonate and Polybutylene Terephtalate.

Those of ordinary skill in the art will appreciate that the components of the access door system 10 may be fabricated from a variety of materials and using a variety of manufacturing techniques and that the foregoing materials and techniques are examples and not limitations. For example, and not limitation although it may be preferred to manufacture the access door system 10 from relatively inexpensive materials such as a plastic, it is within the scope of the present invention to fabricate the access door system 10 from any material, such as a metal, including corrosive resistant metals, such as a stainless steel.

Furthermore, although the present embodiment is shown provided with a first hinge 70 and a second hinge 71, those of ordinary skill in the art will appreciate that it is within the scope of the present invention to utilize any number of hinges, such as, for example, one hinge or more than two hinges. Moreover, although the present embodiment is shown provided with hinges 70, 71 that include open and closed position detent receiving portions 80, 81, those of ordinary skilled in the art will appreciate that it is within the scope of the present embodiment to fabricate the hinges 70, 71 with any number of detent receiving portions, including one or more than two. By way of example, and not limitation, in certain embodiments the hinges 70, 71 may not include the closed position detent receiving portion 81 and the locking member receiving portion 50 on the bezel and the locking member 68 on the door 60 may be relied upon to releasably hold the door 60 in the closed position.

Additionally, those of ordinary skill in the art will appreciate that the bezel 20 may be provided with any number of detents. By way of example, and not limitation, the bezel 20 may be provided with a plurality of detents positioned such that at least one engages a detent receiving portion 80 when in the open position and another engages the detent receiving portion when in the closed position.

Similarly, although the present embodiment is shown provided with a door 60 that includes at least one locking member 68 and a bezel 20 that includes at least one locking member receiving portion 50, those of ordinary skill in the art will appreciate that the it is within the scope of the present embodiment to fabricate the bezel 20 and the door 60 with a plurality of such features or without the respective locking member receiving portion 60 and the locking member 68. By way of example, and not limitation, in such embodiments, the detents 47, 48 and the closed position detent receiving portions 81 may be relied upon to releasably hold the door 60 in the closed position.

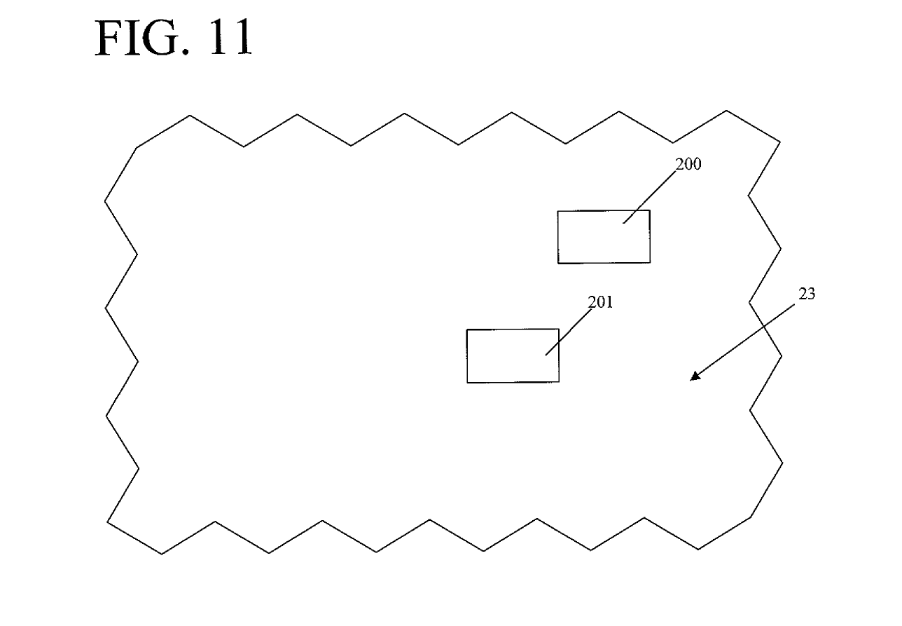

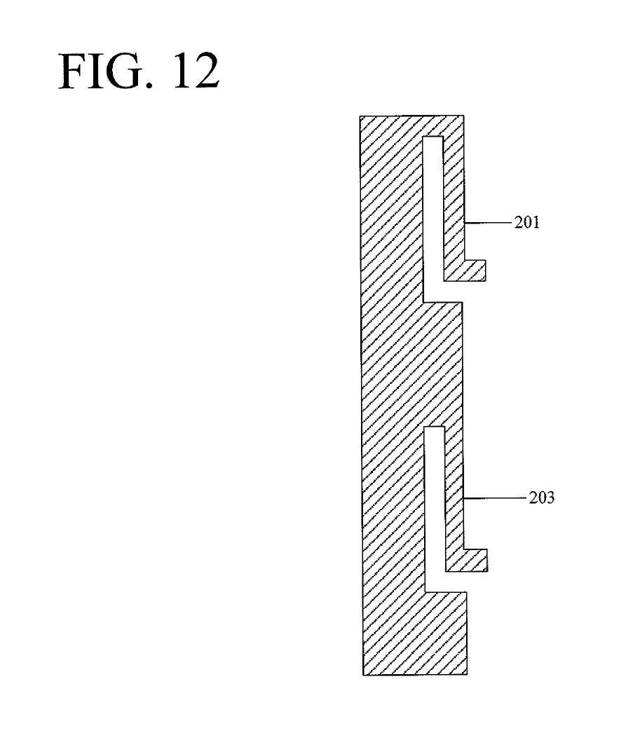

Moreover, those of ordinary skill in the art will appreciate that the location of various cooperating structures on the bezel 20, door 60, and hinges 70, 71 may be reversed. By way of example, and not limitation, the bezel 20 may be provided with one or more detent receiving portion 200, 201, as shown in FIG. 11 and the hinges 70, 71 may be provided with one or more detents 202, 203, as shown in FIG. 12. By way of yet another example, and not limitation, the hinges 70, 71 may be provided with bearings and the bezel 20 may be provided with bearing receiving portions. By way of yet a further example, the door 60 may be provided with a locking member receiving portion and the bezel 20 may be provided with a locking member.

Additionally, although in the present embodiment, the detents 47, 48 cooperate with the open position and closed position detent receiving portions 80, 81 to releasably hold the door 60 in an open position and a closed position, those of ordinary skill in the art will appreciate that the principals of the present embodiment encompass using detents on either the hinges 70, 71 or the bezel 20 and detent receiving portions on either the hinges 70, 71 or the bezel 20 to releasably hold the door 60 in any number of positions.

The present description depicts specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Thus, although specific embodiments of, and examples for, the invention are described herein for illustrative purposes, various equivalent modifications are possible within the scope of the invention, as those skilled in the relevant art will recognize. Accordingly, the scope of the invention is determined from the appended claims.

I claim:

1. An access door system, comprising:
a door provided with an open position and a closed position;
a bezel;
a hinge that connects said door and said bezel, said hinge:
provided with an end journaled to said bezel about an axis of rotation;
rotating about said axis of rotation between a first position, whereat said door is open, and a second position, whereat said door is closed;
one of said hinge or said bezel provided with a detent receiving portion, the other of said door or said bezel provided with a detent, wherein said detent receiving portion releasably receives said detent to releasably hold said door in a position.

2. The access door system according to claim 1, wherein said detent receiving portion is an open position detent receiving portion that releasably receives said detent to releasably hold said door in said open position.

3. The access door system, according to claim 1, wherein:
said detent is provided on said bezel; and
said detent receiving portion is provided on said hinge.

4. The access door system according to claim 1, wherein:
one of said door or said bezel includes a locking member;
the other of said door or said bezel defining a locking member receiving portion; and
said locking member receiving portion releasably receiving said locking member to releasably hold said door in said closed position.

5. The access door system according to claim 1, wherein said hinge is generally J shaped.

6. The access door system according to claim 1, wherein said detent is a flexible member that flexibly snaps into and out of said detent receiving portion.

7. The access door system according to claim 1, wherein said detent is a cantilevered member provided with a hooked end that flexibly snaps into and out of said detent receiving portion.

8. The access door system according to claim 1, wherein said end of said hinge is releasably snap fit to said bezel, whereby said end is releasably journaled to said bezel.

9. The access door system according to claim 1, wherein said detent receiving portion is a recessed area defined within one of said hinge or said bezel.

10. The access door system according to claim 1, further comprising:
a vehicle body defining an opening;
a urea tank access situated within said opening;
said bezel including a lip and a snap clip; and
said underside of said lip and said snap clip securing said bezel to said opening of said vehicle body.

11. The access door system according to claim 10, wherein:
said snap clip includes a ramped surface that protrudes from an outer surface of said bezel and terminates at a retaining surface, wherein said retaining surface and said underside of said lip define a slot that captures a portion of said vehicle body defining said opening.

12. The access door system according to claim 1, wherein:
said detent is provided on said bezel;
said detent receiving portion is provided on said hinge and is an open position detent receiving portion that releasably receives said detent to releasably hold said door in said open position; and
said hinge further includes a closed position detent receiving portion, said closed position detent receiving portion releasably receiving said detent to releasably hold said door in said closed position.

13. The access door system according to claim 12, wherein said open position detent receiving portion is located along said hinge at a position that is closer to said bezel than said closed position detent receiving portion.

14. The access door system according to claim 1, further comprising a vehicle body defining an opening and a urea tank access situated within said opening, wherein:
said bezel includes a lip and a snap clip;
said snap clip includes a ramped surface that protrudes from an outer surface of said bezel and terminates at a retaining surface, wherein said retaining surface and said underside of said lip define a slot that captures a portion of said vehicle body defining said opening;
said detent is provided on said bezel and is a cantilevered member provided with a hooked end that flexibly snaps into and out of said detent receiving portion;
said detent receiving portion is provided on said hinge, as a recessed area defined within said hinge, and is an open position detent receiving portion that releasably receives said detent to releasably hold said door in said open position;
said hinge further includes a closed position detent receiving portion, as a recessed area defined within said hinge, said closed position detent receiving portion releasably receiving said detent to releasably hold said door in said closed position;
said open position detent receiving portion is located along said hinge at a position that is closer to said bezel than said closed position detent receiving portion;
one of said door or said bezel includes a locking member;
the other of said door or said bezel defining a locking member receiving portion;
said locking member receiving portion releasably receiving said locking member to releasably hold said door in said closed position; and
said hinge is generally J shaped and said end of said hinge is releasably snap fit to said bezel, whereby first end is releasably journaled to said bezel.

15. The access door system according to claim 1, further comprising:
another hinge that connects said door and said bezel, said another hinge:
provided with another end journaled to said bezel about said axis of rotation;
rotating about said axis of rotation between another first position, whereat said door is open, and another second position, whereat said door is closed; and
one of said another hinge or said bezel provided with another detent receiving portion, the other of said door or said bezel provided with another detent, wherein said another detent receiving portion releasably receives said another detent to releasably hold said door in said position.

16. The access door system according to claim 15, wherein said detent receiving portion is an open position detent receiving portion that releasably receives said detent to releasably hold said door in said open position.

17. The access door system according to claim 15, wherein:
said hinge includes an inward facing side and said another hinge includes an inward facing side, wherein said inward facing side and said another inward facing side generally face each other;
said hinge includes an outward facing side that faces in a generally opposite direction than said inward facing side;
said another hinge includes another outward facing side that faces in another generally opposite direction than said another inward facing side;
said hinge including one of said detent or said detent receiving portion located on said outward facing side of said hinge; and
said another hinge including one of said another detent or said another detent receiving portion located on said outward facing side of said another hinge.

18. The access door system according to claim 15, wherein:
said detent and another detent are provided on said bezel;
said detent receiving portion is provided on said hinge and is an open position detent receiving portion that releasably receives said detent to releasably hold said door in said open position;
said another detent receiving portion is provided on said another hinge and is an another open position detent receiving portion that releasably receives said detent to releasably hold said door in said open position;
said hinge further comprises a closed position detent receiving portion, said closed position detent receiving portion releasably receiving said detent to releasably hold said door in said closed position; and
said another hinge further comprises another closed position detent receiving portion, said another closed position detent receiving portion releasably receiving said detent to releasably hold said door in said closed position.

19. The access door system according to claim 18, wherein:
said open position detent receiving portion is located along said hinge at a position that is closer to said bezel than said closed position detent receiving portion; and
said another open position detent receiving portion is located along said hinge at a position that is closer to said bezel than said another closed position detent receiving portion.

20. The access door system according to claim 15, further comprising a vehicle body defining an opening and a urea tank access situated within said opening, wherein:
said bezel includes a lip and a snap clip;
said snap clip includes a ramped surface that protrudes from an outer surface of said bezel and terminates at a retaining surface, wherein said retaining surface and said underside of said lip define a slot that captures a portion of said vehicle body defining said opening;
said detent and another detent are provided on said bezel and are cantilevered members provided with hooked ends that flexibly snaps into and out of said detent receiving portion and said another detent receiving portion;
said detent receiving portion is provided on said hinge, as a recessed area defined within said hinge, and is an open position detent receiving portion that releasably receives said detent to releasably hold said door in said open position;
said hinge further includes a closed position detent receiving portion, as a recessed area defined within said hinge, said closed position detent receiving portion releasably receiving said detent to releasably hold said door in said closed position;
said another detent receiving portion is provided on said another hinge, as a recessed area defined within said another hinge, and is another open position detent receiving portion that releasably receives said detent to releasably hold said door in said open position;
said another hinge further includes a closed position detent receiving portion, as a recessed area defined within said hinge, said closed position detent receiving portion releasably receiving said detent to releasably hold said door in said closed position;
said open position detent receiving portions are located along said hinges at positions that are closer to said bezel than said closed position detent receiving portions;
one of said door or said bezel includes a locking member;
the other of said door or said bezel defining a locking member receiving portion;
said locking member receiving portion releasably receiving said locking member to releasably hold said door in said closed position;
said hinges are generally J shaped and said ends of said hinges are releasably snap fit to said bezel, whereby first ends are releasably journaled to said bezel;
said hinge includes an inward facing side and said another hinge includes an inward facing side, wherein said inward facing side and said another inward facing side generally face each other;
said hinge includes an outward facing side that faces in a generally opposite direction than said inward facing side;
said another hinge includes another outward facing side that faces in another generally opposite direction than said another inward facing side;
said hinge including said open and closed position detent receiving portions on said outward facing side of said hinge; and
said another hinge including said another open and closed position detent receiving portions on said outward facing side of said another hinge.

21. An access door system, comprising:
a bezel provided with:
means for cooperating with a hinge so that said hinge is releasably journaled to said bezel; and
means for cooperating with said hinge to releasably hold said hinge in a position.
